(19) United States
(12) Patent Application Publication
(10) Pub. No.: US 2009/0202846 A1
(43) Pub. Date: Aug. 13, 2009

(54) THERMALLY ADAPTIVE SURFACES FOR RECEIVING THERMAL SPRAYS

(76) Inventors: Mohan Jayaraman, Nashua, NH (US); Michael Draper, Lancs (GB)

Correspondence Address: GAUTHIER & CONNORS, LLP, 225 FRANKLIN STREET, SUITE 2300, BOSTON, MA, 02110, US

(21) Appl. No.: 12/367,173

(22) Filed: Feb. 6, 2009

Related U.S. Application Data
(60) Provisional application No. 61/027,097, filed on Feb. 8, 2008.

(51) Int. Cl. B32B 25/04; C23C 4/12; B32B 15/04; C23C 4/06; C23C 4/10

(52) U.S. Cl. 428/457; 427/446; 428/698; 428/689

(57) ABSTRACT

A method is disclosed for applying thermal spray particles to a composite, wherein the method includes the steps of providing a composite that includes a thermally sensitive surface, and applying the thermal spray particles at a temperature that is high enough to cause a temperature-dependent change in the thermally sensitive surface of the composite. The temperature-dependent change improves adhesion between the thermal spay particles and the composite.

### PRIORITY

This application claims priority to U.S. Provisional Patent Application Ser. No. 61/027,097 filed on Feb. 8, 2008.

### BACKGROUND OF THE INVENTION

1. Field of the Invention

The invention relates to the development and manufacture of components for papermaking systems, and relates in particular to such components (e.g., doctor blades or dewatering members) that are intended to receive an atmospheric thermal spray coating surface.

2. Description of the Prior Art

The use of coating materials to improve desirable characteristics such as hardness or wear resistance of an underlying substrate is well known. A challenge, however, is typically presented by trying to provide sufficient adhesion between the coating material and the underlying substrate, and a variety of techniques have been developed that seek to improve the adhesion between such coating materials and various substrates.

European Patent No. 0 262 137, for example, discloses a surface treating machine that employs pressure to treat a surface wherein at least part of the pressure on a movable head is derived from the weight of the treating machine itself.

In other applications, the wear resistance of a material used in a roll processing machine (such as a papermaking system) may be dramatically improved through use of a ceramic, carbide or other harder metals or materials that is applied to the surface of the substrate as a thermal spray. While many metals are receptive to such thermal sprays, thermally spraying composite substrates and surfaces thereof poses a challenge. The term composite generally includes fiber reinforced thermosetting resins or fiber reinforced thermoplastic resins as is well known in the plastics and composite industry. Such composites offer many advantages over their metal counterparts, including that they are lighter and easier to handle, and under abrasive wear conditions, they will not spark, thereby mitigating the risk of fires. Composites are also much gentler on the mating surface, which is a concern if the mating surface is made from soft and/or compressive materials such as pressure rolls used in papermaking systems.

Initially, coatings had weak adhesion on composite substrates and were useful only for limited applications such as RFI shielding which require only the presence of metal and its electrical contact with the substrate but no adhesion strength. Such weakly adhered coatings do not provide meaningful wear or abrasion resistance.

In order to improve adhesion to composite substrates, various techniques have been employed. U.S. Pat. No. 6,687,950 discloses the use of an anchor structure in a composite material use for doctor blades and doctor blade holders, wherein the anchor structure is disclosed to improve adhesion between a high temperature thermal coating and the composite. The anchor structure is disclosed to include metal wire, wire mesh, metal foil, or metal powder. The use of such anchor structures may be commercially expensive and cumbersome to manufacture in certain applications. Moreover, the objective of not using metals (due to possible damage inflicted to the mating surface) is defeated by the use of metal in the form of strips, wires, brushes etc.

U.S. Pat. No. 7,291,248 discloses the use of an adhesion layer between a composite and a thermal spray coating. The adhesion layer is disclosed to include a metallic filler (e.g., nickel-chromium particles/fillers), and the adhesion layer is disclosed to be applied to the composite from a bath. The use of such an adhesion layer also involves metals, and is not suitable for certain applications.

European Patent EP 1 573 125 discloses improving the adhesion between a treatment blade, such as a coating, doctor or creping blade, and a wear-resistance coating by roughening the contact surface of the blade (to a coarseness of about 3-6 μm) using grinding traces that extend in the running direction of a paper web. Such grinding steps, however, add manufacturing expense and are not suitable for some applications.

U.S. Pat. No. 7,390,561 discloses a coating process that involves applying a thermal spray material onto a release agent layer, then integrating the thermal spray material layer into a composite, and then separating the release agent layer from the composite. Such a technique, however, is also not suitable for certain applications, at least in part, because it may be difficult to employ for large objects, strips or beams of composite material.

There continues to be a need to improve the adhesion between thermal sprays and composite substrates, and there is further a need for improving such adhesion without using metallic materials.

### SUMMARY

It is an object of the invention to provide improved adhesion between thermal spray particles and a composite substrate used, for example, in a papermaking machine.

Another object of the invention is to provide a composite with a surface that has a desired damping property for receiving the thermal spray particles.

Another object of the invention is to provide a composite that includes in situ formed pore-network structures that enhance adhesion.

In accordance with an embodiment, the invention provides a method of applying thermal spray particles to a composite, wherein the method includes the steps of providing a composite that includes a thermally sensitive surface, and applying the thermal spray particles at a temperature that is high enough to cause a temperature-dependent change in the thermally sensitive surface of the composite. The temperature-dependent change improves adhesion between the thermal spay particles and the composite. In some embodiments, the composite includes low temperature fibers or fiber bundles, while in other embodiments, the composite includes a low temperature layer of thermoplastic. The term fiber and fiber bundles are sometimes used interchangeably depending on the construction of the composite under discussion.

In accordance with a further embodiment, the invention provides a composite material that includes an outer surface that is adapted to receive a thermal spray. The outer surface has a hardness of less than about 50 HRB and is adapted to absorb a sufficient amount of impact from particles at high velocity from the thermal spray such that the particles adhere to the surface.

### BRIEF DESCRIPTION OF THE DRAWINGS

The following description may be further understood with reference to the accompanying drawings in which:

FIG. 1 shows a composite having a thermally adaptive surface in accordance with an embodiment of the invention;

FIGS. 2A-2C show a thermal spray particle prior to contact with a prior art composite, upon contact with the prior art composite, and following impact with the prior art composite;

FIGS. 3A-3C show a thermal spray particle prior to contact with a composite of the invention, upon contact with the composite of the invention, and following impact with the composite the invention in accordance with an embodiment;

FIGS. 4A and 4B show a composite in accordance with an embodiment of the invention prior to being subjected to the heat of a thermal spray, and during application of a thermal spray in accordance with an embodiment of the invention;

FIG. 5 shows a composite in accordance with another embodiment of the invention during application of a thermal spray; and

FIG. 6 shows a composite in accordance with a further embodiment of the invention that includes non-planar surface that is adapted to receive a thermal spray.

The drawings are shown for illustrative purposes only.

### DETAILED DESCRIPTION

It has been discovered that the disadvantages and problems of the prior art arrangements can be avoided by the arrangement according to the invention in which any composite material can be made receptive to thermal sprays by the addition of a surface layer with specific characteristics designed to increase the adhesion of thermal sprays on the surface by providing that the surface is thermally adapted to receive the thermal spray. The entire composite may have the thermally adaptive functionality, or the composite may be coated with a material that has the thermally adaptive functionality.

In accordance with an embodiment, the composite provides desired properties such as strength, stiffness, electrical conductivity etc, as composites may be much lighter than metals yet may be provided having great strengths. Carbon fiber reinforced composites are used in many applications, including for example, aircraft industry components and machine processing equipment such as papermaking machines. Such composites alone, however, may not have sufficient the wear resistance, and a thermal spray of carbide (e.g., tungsten carbide) or ceramic (e.g., chrome oxide) or other functional coatings may be applied on a surface of the composite.

Thermal sprays generally consist of individual particles in a molten or semi molten state that are travelling very quickly when the thermal spray is applied to an article. It is known in the thermal spray industry that efficiency and adhesion are related directly to the ability of the particles to stick to the mating surface and remain with the mating surface. It is also known that these individual particles have an inherent tendency to bounce off of the surface.

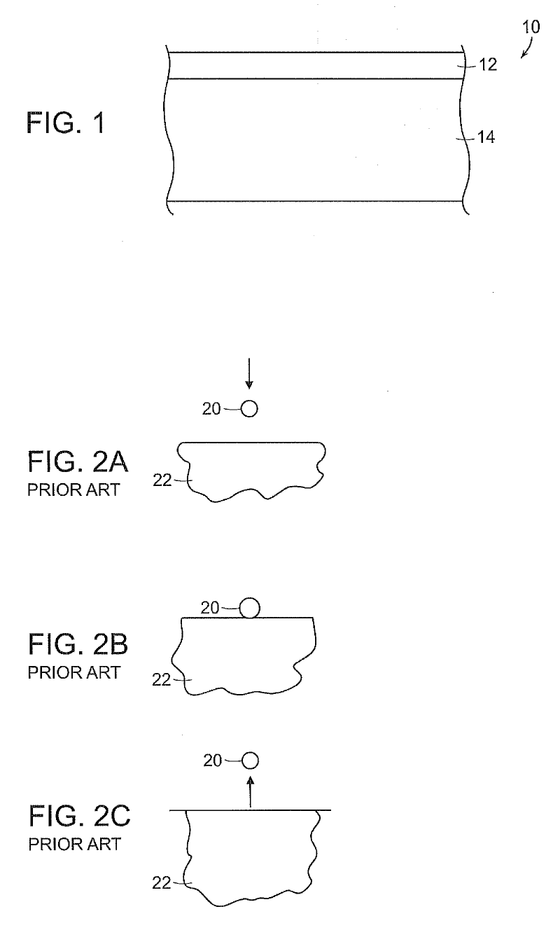

With reference to FIG. 1, a composite 10 may include an outer surface 12 on a substrate 14. The outer surface 12 is somewhat compliant, and is therefore, adapted to better absorb the shock of impact, providing improved conditions for the particles to stick. Once the initial layer is deposited, subsequent layers will have no adhesion issues because they will attach to the initial deposited layer of thermal spray. In accordance with various embodiments, the invention provides the use of a compliant layer on top of adequate thickness and of a sufficiently cushioning nature to absorb the shock of particulate impact. The hardness of the outer surface in the range 10-50 HRB will function well for most thermal sprays, though the range 20-35 HRB works even better and is the preferred range.

For example, FIG. 2A show a particle 20 just prior to impact with a prior art surface 22. As shown in FIGS. 2B and 2C, due to elastic surface deformation of the surface 22, the particle is received by the surface (FIG. B) such that energy is stored in the elastic deformation of the surface, and the particle then bounces off of the surface (FIG. 2C) when the surface 22 recovers, transferring the stored elastic deformation energy back to the particle 20.

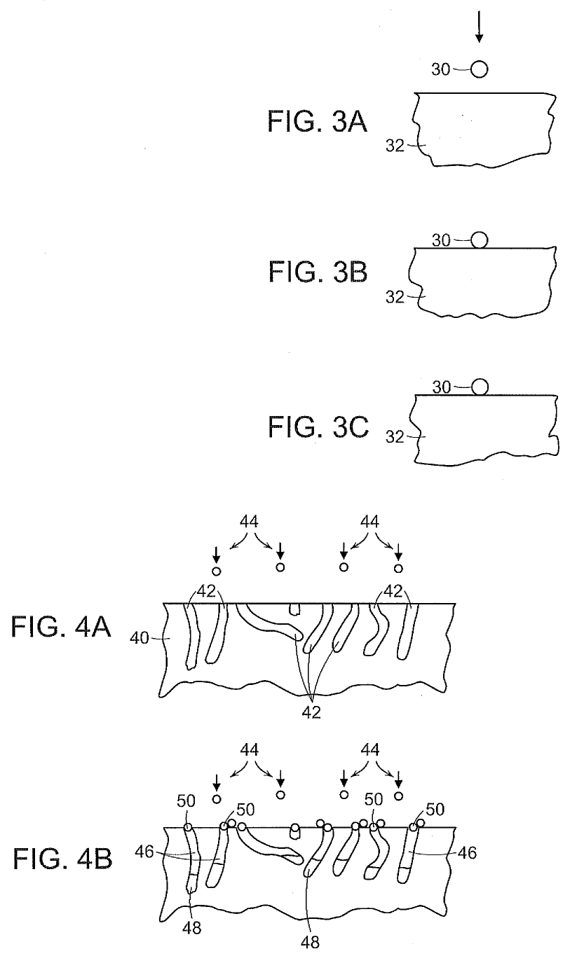

In accordance with an embodiment of the invention, as with reference to FIGS. 3A-3C, when a particle 30 contacts a thermally adaptive surface of a composite 32 of an embodiment of the invention, the energy from the particle's high velocity movement (shown in FIG. 3A) becomes absorbed by the composite 32 as the particle as well as the surface undergo some plastic deformation (as shown in FIG. 3B), permitting the particle 30 to remain with the composite 32 (as shown in FIG. 3C). The outer surface of the composite 32 includes a low temperature material (below about 500° C., and preferably below about 450° C., which softens when exposed to the heat of the thermal spray.

In accordance with further embodiments, low temperature filler material such as fibers and/or fiber bundles (example, as part of a woven construction in a resin impregnated sample) may be provided in an outer surface of the composite. FIGS. 4A and 4B show a partial sectional view of a composite 40 that include low temperature fibers 42 (e.g., cotton fibers) at a surface of the composite. When the composite and fibers are subjected to the high temperature of a thermal spray 44, the low temperature fibers burn up, leaving voids 46 and possibly some remaining residue 48. The thermal spray particles 50 may then become engaged with the voids 46, permitting some particles to become stuck to the composite 40, while others stick to the particles that are engaged with the voids 46.

In this embodiment, the fibers at the outer surface are intentionally destroyed, either completely or partially, due to the heat of the high temperature thermal spray. Cotton, for example begins to degrade at temperatures as low as 120-150C. This is true even though the ignition point of cotton is higher at 407 C, with fire point being at 210C. The nature, magnitude and speed of decomposition will determine the usefulness of the fiber in this function. In this case, the thermal sprayed particles will partially destroy the cotton fibers and create micro pockets on the surface of the composite. These pores are of the diameter of the individual cotton fiber which may be in the range 1-10 μm. They may also be of the diameter of the fiber bundle which varies considerably in the industry from 0.1 mm or smaller in the case of fine cotton fabric to about 1 mm or higher for coarse cloth. The pore diameters, which may range from about 1 μm to 1 mm, also depend, to some extent on the fiber type used because the nature, magnitude and rate of decomposition also affect the residual pore size, shape, distribution and network. These pores provide the anchor points for the first layer of thermal spray and improve adhesion dramatically. With high temperature thermal sprays, corresponding higher temperature fibers and resins may be used.

Many natural or manmade fibers may be successfully used. Cotton is used as an example throughout due to convenience and familiarity to the average reader. It may be noted that cotton and linen, both plant fibers burn and leave ash but have different flame characteristics. When ignited cotton burns with a steady flame. The ash left is easily crumbled and blown away. Linen is also a plant fiber but different from cotton in that the individual plant fibers which make up the yam are long where cotton fibers are short. Linen takes longer to ignite. The fabric closest to the ash is very brittle. Linen is easily extinguished by blowing on it as you would a candle. Silk and wool are both protein fibers, but again have different characteristics. Silk usually burns readily, not necessarily with a steady flame, and smells like burning hair. The ash is easily crumbled but may sometimes be sticky. Silk fibers are not as easily extinguished as cotton or linen. Wool is harder to ignite than silk as the individual “hair” fibers are shorter than silk and the weave of the fabrics is generally looser than with silk. The flame is steady but more difficult to keep burning. Acetate is made from cellulose (wood fibers), technically cellulose acetate. Acetate burns readily with a flickering flame that cannot be easily extinguished. The burning cellulose drips and leaves a hard ash. Acrylic (technically acrylonitrile) is made from natural gas and petroleum. Acrylics burn readily due to the fiber content and the air filled pockets. An open flame shown on an acrylic fibers can ignite the fabric which will burn rapidly unless extinguished. The ash is hard. Nylon is a polyamide made from petroleum. Nylon melts and continues to burn only in the presence of an active independent fire. Polyester is a polymer produced from coal, air, water, and petroleum products. Polyester melts and burns at the same time, the melting, burning ash can bond quickly to any surface it drips on. The extinguished ash is hard. Rayon is a regenerated cellulose fiber which is almost pure cellulose. Rayon burns rapidly and leaves only a slight ash. The list of fibers is long and the above is not to be considered a complete list.

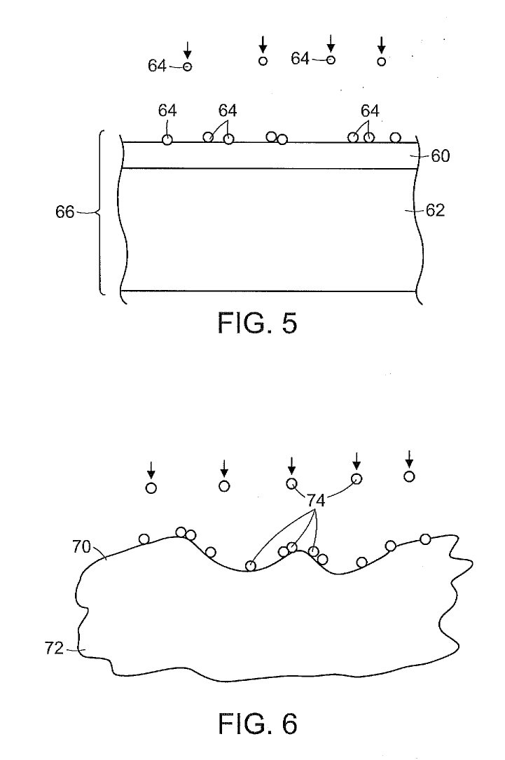

Another innovation in this application is the use of low temperature thermoplastics in the outer layer 60 of the substrate material 62 as shown in FIG. 5. In this case the thermoplastic resin absorbs the heat of the thermal spray and partially melts (or softens) and hence provides the surface characteristics of damping and energy absorption required for improved adhesion of the particles 64 to the composite layer 60. The energy absorbed and dissipated prevents the thermal spray particles 64 from bouncing off of the composite 66. This is because thermoplastics melt (as opposed to thermo-sets which do not) and hence it is possible to exploit the inherent characteristics of the resin layer to provide the overall properties of energy absorption to improve adhesion.

Sample results of adhesion between a composite (provided as a round slug of thermo plastic HC-460) and a high temperature thermal spray coating in accordance with an embodiment of the invention are shown in Table 1 below.

TABLE 1

| Sample | | | Pull | |
|---|---|---|---|---|
| Number | Diameter | Area | lbs | PSI |
| Thermo plastic HC-460 | 0.990 | 0.7698 | 2100 | 2728.1 |
| Thermo plastic HC-460 | 0.994 | 0.7760 | 2100 | 2706.2 |
| Thermo plastic HC-460 | 0.985 | 0.7620 | 2000 | 2624.6 |
| Average | | | 2,066.7 | 2,686.3 |

Similar excellent results were achieved with cotton based substrates using a thermoset resin system.

The functional composite part to which the thermal spray is to be added maybe made by any number of methods known to the industry. For example, lamination, pultrusion, hand lay up, molding, extrusion are all examples of processes that may be employed, and others are available and known to the industry. The surface layer may be attached either at the time of manufacture or later. An important aspect of certain embodiments of the invention involves choosing the correct properties, energy absorption or damping properties specifically in one case and in situ pore formation in the other case, of the surface layer so it can absorb the impact shock of the spray particulates.

All materials that may be sprayed are candidates for consideration depending on the specific duty required and as discussed in an example above. If wear resistant coatings are required low priced and chemically robust ceramics are desired such as oxides of Aluminum (Al₂O₃) or Chromium (Cr₂O₃). The composite part may be coated in whole or only a specific part may be coated. This could be due to a number of reasons including cost, manufacturing set up convenience, functionality etc and these reasons are all known to those familiar with the thermal spray industry. The part could be thermal spray coated in a batch operation or in a continuous mode. Once the spray is complete, subsequent grinding or finishing operations may be done to it so as to adapt it to a specific duty. In the tissue manufacture industry, for example, the doctor blade, specifically called the creping blade, has a precise bevel at the end where the blade negotiates the Yankee and pulls (crepes) the tissue paper off. This bevel is always one of the last operations as it requires accuracy and consistency. Benefits of methods and composites of the invention may be employed in a wide variety of industries, permitting specific products to be much more functional, easier to manufacture and having improved thermal spray applicability.

The composite that is adapted to receive the thermal spray in accordance with certain embodiments of the invention may be planar (for example, for use as a doctor blade in a papermaking machine) or may be non-planar (for example, where the shape is designed for the use with high wear aeronautics equipment). FIG. 6 shows at 70 a non-planar surface of a composite 72 that is adapted to facilitate adhesion of thermal spray particles 74 onto the surface 70. The composite 72 may include either low temperature filler material or a low temperature outer surface coating as discussed above.

Other variations of the disclosed innovation are within the intended scope of this invention as claimed below. For example low temperature filled or unfilled rubbers and other artificial compounds may easily provide simultaneously the desired resiliency as well as the in situ pore formation as necessary. Hence it is to be understood that the disclosed embodiments are merely exemplary of the invention that may be embodied in various forms.

Those skilled in the art will appreciate that numerous modifications and variations may be made to the above disclosed embodiments without departing from the spirit and scope of the invention.

What is claimed is:

1. A method of applying thermal spray particles to a composite, wherein said method includes the steps of providing a composite that includes a thermally sensitive surface, and applying the thermal spray particles at a temperature that is high enough to cause a temperature-dependent change in the thermally sensitive surface of the composite, wherein the temperature-dependent change improves adhesion between the thermal spay particles and the composite.

2. The method as claimed in claim 1, wherein said composite includes in a least a surface portion thereof, low temperature material within the composite that irreversibly changes when subjected to the thermal spray particles at a high temperature.

3. The method as claimed in claim 2, wherein said low temperature material includes low temperature fibers.

4. The method as claimed in claim 3, wherein said low temperature fibers are cotton fibers.

5. The method as claimed in claim 2, wherein the irreversible change involves providing pores having diameters of about 1 μm to 1 mm.

6. The method as claimed in claim 1, wherein said composite includes in at least a surface portion thereof, a low temperature resin material that softens when subjected to the thermal spray particles at a high temperature.

7. The method as claimed in claim 6, wherein said low temperature resin material includes rubber compound.

8. The method as claimed in claim 1, wherein said composite has a hardness of about 10-50 HRB.

9. The method as claimed in claim 1, wherein said composite has a hardness of about 20-35 HRB.

10. The method as claimed in claim 1, wherein said method further includes the steps of permitting the thermal spray particles to form a first layer, and applying further thermal spray particles to form a second layer of thermal spray particles.

11. The method as claimed in claim 1, wherein the temperature is below about 500° C.

12. A composite material including an outer surface that is adapted to receive a thermal spray, said outer surface having hardness of less than about 50 HRB and being adapted to absorb a sufficient amount of impact from particles at high velocity from the thermal spray such that the particles adhere to the surface.

13. The composite material as claimed in claim 12, wherein said composite material has a hardness of about 10-50 HRB.

14. The composite material as claimed in claim 12, wherein said composite material has a hardness of about 20-35 HRB.

15. The composite material as claimed in claim 12, wherein said composite material includes low temperature filler that become at least partially destroyed at temperatures below about 450C thereby leaving open pores within the composite material.

16. The composite material as claimed in claim 12, wherein said low temperature filler includes fibers.

17. The composite material as claimed in claim 16, wherein said fibers are cotton fibers.

18. The composite material as claimed in claim 12, wherein said composite material includes thermoplastic resin that at least partially softens under heat of the thermal spray particles to absorb an impact of thermal spray particles on a surface of the composite material.

19. The composite material as claimed in claim 12, wherein said composite material includes rubber that at least partially softens under heat of the thermal spray particles to absorb an impact of thermal spray particles on a surface of the composite material.

20. The composite material as claimed in claim 12, wherein the outer surface of said composite is non-planar.

21. The composite material as claimed in claim 12, wherein the outer surface of said composite is planar.

22. The composite material as claimed in claim 12, wherein said composite is a doctor blade for use in a papermaking machine.
